(19) United States
(12) Patent Application Publication
(10) Pub. No.: US 2004/0257906 A1
(43) Pub. Date: Dec. 23, 2004

(54) Motion element for small quanities of liquid

(76) Inventors: Jurgen Scriba, Munchen (DE); Christoph Gauer, Minchen (DE)

Correspondence Address: Rocco S Barrese, Dilworth & Barrese, 333 Earle Ovington Boulevard, Uniondale, NY, 11553, US

(21) Appl. No.: 10/488,372

(22) PCT Filed: Mar. 4, 2002
(86) PCT No.: PCT/EP02/02340

(30) Foreign Application Priority Data
Aug. 31, 2001 (DE) 101 42 789.1

(51) Int. Cl. B01F 11/02

(52) U.S. Cl. 366/127

(57) ABSTRACT

The invention relates to a motion element for producing motion in small quantities of liquid comprising a plate-shaped member having two principal surfaces, wherein at least one motion device, which is electrically controllable, is arranged on a first active principal surface to set in motion a liquid which is in contact with the active principal surface, and electrical contact elements for the motion device. The invention furthermore relates to a motion device which can be used with the motion element according to the invention, a cartridge to receive a motion element according to the invention, a reaction device to receive a cartridge according to the invention and a method for producing motion in small quantities of liquid.

The invention relates to a motion element for moving small quantities of liquid, a motion device which can preferably be used in a motion element according to the invention, a cartridge to receive a motion element according to the invention, a reaction device to receive the cartridge and a method for producing motion in small quantities of liquid.

In chemical, biological or microbiological analysis it is frequently necessary to bring substances contained in a liquid film in-contact with other-substances deposited on a slide for example and bring them to reaction. Thus, for example, a fast method for analysing macromolecules involves using a so-called microarray in which known first, possibly different, types of macromolecules are arranged at different positions, e.g. in a template form. These macromolecules are also known as “probe molecules”. A liquid containing second macromolecules (“sample molecules”) is flushed over the microarray, and these form a specific bond with at least one type of probe molecules on the microarray (hybridisation). If the liquid is then removed from the surface again, only the sample molecules to be studied are retained chiefly at the specific binding sites. The sites at which sample molecules are present can be determined using spatially resolved measurement, e.g. a fluorescence measurement. From the known position of the individual probe molecules in the template form of the microarray it is thus possible to determine the type of macromolecules with which the macromolecules to be studied have formed a specific bond.

Such microarrays are used, for example, to study macromolecules such as proteins, antigens or antibodies. Microarrays are especially also used to study DNA, e.g. for DNA screening.

The duration of a corresponding analytical experiment is determined to a substantial extent by the diffusion of the sample molecules to the probe molecules and this can take some time. For example, if the concentration of the macromolecule to be studied in the liquid is only low, it can take a very long time before it has found its specific binding partner on the array. It would thus be desirable to have a device with which the liquid can be thoroughly mixed in order to achieve a homogeneous distribution of macromolecules on the microarray at every point in time.

A device supplied by “Molecular Dynamics” describes a microarray slide processor where a cover plate is placed over a circumferential rubber seal on a slide with a microarray and screwed down. The intermediate space between the cover plate and slide completely sealed in this fashion can be filled by a filling septum. The intermediate space can be flushed with liquid through another access. With such a device the entire slide comes in contact with liquid. In this case, the volume of liquid is larger than that in an experiment carried out manually firstly because at most half the slide is biologically active and secondly because the flushing requires quite a considerable dead volume.

Small quantities of liquid are frequently manipulated in microfluidic systems consisting of microchannels which are used to guide, mix or react the small quantities of liquid (as described, for example, in O. Müller, Laborwelt No. 1/2000, page 36ff). In this case, the problem of thoroughly mixing or agitating the small quantities of liquid frequently arises. By using a wide range of methods an attempt is made to convert the predominantly laminar flow in microchannels into a turbulent flow. For example, ridges can be provided at the edge of the channels or the channels can have multifurcations which are then brought together again, these devices being installed fixedly and not controllable.

The object of the present invention is to provide devices which allow effective and simple thorough mixing of quantities of liquid or the substances contained therein on or in a support material. The devices should be cheap and easy to handle.

This object is solved with a motion element having the features of claim 1, a motion device having the features of claim 18, a cartridge for a motion element having the features of claim 28, a reaction device having the features of claim 36, a system according to claim 38, a method having the features of claim 23 or a method having the features of claim 27.

The motion element according to the invention for producing motion in small quantities of liquid comprises a plate with two principal surfaces of which one is an active principal surface. Located on this active principal surface is at least one motion device which is electrically controllable in order to set in motion a liquid in contact with the active principal surface. Furthermore, the motion element comprises electrical contact elements for contacting the motion device.

In this connection the electrical contact elements can either be developed for direct physical contact with electrical leads or as antenna devices for receiving a suitably emitted alternating field for wireless control.

The term “liquid” in the present text comprises, among other things, pure liquids, mixtures, dispersions and suspensions in which solid particles, e.g. biological material, are located.

A liquid located on a support, such as a slide for example, can be agitated with such a motion element. Electrical control of the motion device produces motion in the liquid which in turn brings about effective and homogeneous distribution and/or thorough mixing of the liquid or the substances contained therein. As a result of the plate shape, a motion element according to the invention, is easy to handle and can be simply placed on the support via suitable spacers.

The motion element according to the invention in the same way as the other devices according to the invention and the method according to the invention can be used to thoroughly mix a liquid, to mix a plurality of liquids together and/or to produce a flow in a small quantity of liquid.

Furthermore, the motion element according to the invention can also be used with conventional microfluidics components for example. In this case the motion element according to the invention can be placed with its active side on the entire or on a part of the conventional microfluidic component so that liquid in the area of the microfluidic element located therebelow can be thoroughly mixed using the motion device. In this way, the motion element according to the invention can be used with all feasible conventional fluidic systems made of plastic, silicon, glass etc.

A particular embodiment of the motion element comprises at least one surface acoustic wave generating device as the motion device. A surface acoustic wave makes it possible to produce a force effect on the liquid or on constituents contained therein by momentum transfer either by mechanical deformation of the surface or by interaction of the accompanying electric fields with charged or polarised matter in the liquid. In this way, effective motion and/or thorough mixing of the liquid is achieved which assists the distribution of the liquid.

It is especially advantageous if various surface acoustic wave generating devices are arranged laterally offset to one another. A non-stationary flow pattern can thereby be achieved if the various surface acoustic wave generating devices are successively excited according to a suitable program to generate surface acoustic waves. This is especially advantageous because in small quantities of liquid the flow is usually laminar and a stable flow pattern would thus be established with only one surface acoustic wave generating device. A non-stationary flow pattern enhances the thorough mixing or distribution of suspended matter or macromolecules located in the liquid.

A piezoelectric substrate or a substrate with a piezoelectric surface is advantageously used to generate surface acoustic waves. The piezoelectric substrate can, for example, be made of lithium niobate or quartz or it can comprise a piezoelectric coating, e.g. of zinc oxide. At least one interdigital transducer, as is known from surface wave filter technology, is advantageously located on the piezoelectric substrate as a surface acoustic wave generating device. In its simplest design an interdigital transducer comprises two electrodes with finger-like intermeshing extensions. Such interdigital transducers are described, for example, in R. M. White and F. W. Voltmer, Applied Physics Letters 7, pages 314ff (1965). Application of an alternating electric field to the two electrodes produces a surface acoustic wave on a piezoelectric surface when the resonance condition is satisfied that the frequency corresponds to the quotient of the surface acoustic velocity of the material used and the finger spacing of the interdigital transducer. Typically used frequencies lie in the range of a few tens to a few hundreds of MHz. A defined surface acoustic wave can be generated in a very simple fashion by using an interdigital transducer. The interdigital transducer can be produced cheaply and simply on the piezoelectric substrate using known lithographic methods and coating technologies.

In one embodiment with interdigital transducers, an arrangement with interdigital transducers of different resonance frequency arranged spatially separated on the substrate is suitable for producing non-stationary flow patterns. These transducers can be switched in parallel and in this way require only two electrical connections in total. The individual transducers can be controlled by changing the frequency of the applied alternating voltage. Controlling different transducers results in respectively characteristic flow patterns where the frequency, the pulse-pause ratio, the intensity and the time can be used as parameters. Control can be achieved by electrical contact or however by wireless emission of a suitable alternating field.

The motion device can, for example, be glued on the active principal surface of the motion element. However, it is especially advantageous if the motion device is provided in a recess of the active surface so that the surface acoustic wave generating device and the active surface lie in one plane. This ensures optimum transfer of the surface acoustic wave momentum to the liquid in contact with the active principal surface and the surface acoustic wave generating device.

The motion device can advantageously be inserted in the recess using a capillary adhesion process. The motion device or the corresponding substrate is placed in the recess which has dimensions slightly larger than the motion device itself. Liquid adhesive is inserted in the gap which is distributed uniformly in the gap as a result of capillary action and fills this without any joints.

In an advantageous embodiment there is additionally provided a receiving recess in the active principal surface, in which a slide can be inserted. The dimensions of this receiving recess advantageously allow receipt of a conventional glass slide. In particular, the height of this receiving recess is matched to the thickness of a conventional slide. A slide on which, for example, a functionalisation in the form of a microarray is located, can be inserted in this receiving recess. A liquid can then be applied to the active principal surface of the motion element, which is distributed on the active principal surface and thus contacts the slide and the motion device. Controlling the motion device, e.g., applying an alternating voltage to an interdigital transducer of an embodiment of the motion device, produces motion in the liquid. This motion acts through the entire liquid also on that part of the liquid located on the slide and thus results in effective thorough mixing and distribution of the liquid on the slide.

In one embodiment with a surface acoustic wave generating device it can be advantageous if the surface on which the surface acoustic wave generating device is located is provided with holes, preferably smooth-walled blind holes. Such holes must be dimensioned so that they are not filled by the liquid as a result of their surface tension and the air cushion which forms. However; effective thorough mixing with the aid of surface acoustic waves is promoted by such holes.

Particularly good handling properties are ensured if the plate-shaped support is arranged as card-shaped, for example, it can have dimensions comparable to those of a conventional slide. Such cards are easy to handle and can be manufactured simply and cheaply. Possible dimensions correspond to those of a conventional slide, e.g. about 25×75 mm.

The card-shaped arrangement is robust and serves to protect the more sensitive motion device. The card is easy to handle and is not sensitive during handling and is cheaper than using purely crystalline substrates.

In a particular embodiment of the motion element according to the invention there is provided a through hole which connects the active principal surface to the second principal surface. Such an embodiment can be used especially advantageously to produce a thin liquid film between a support and the motion element. If necessary, spacers are arranged between support and motion element, which spacers are either arranged separately or formed integrally with the support or the motion element. A gap forms between support and motion element. The active surface of the motion element points towards the support. A liquid can now be inserted in this gap through the through hole, for example, using a pipette or a dispenser. The gap can be dimensioned such that the liquid spreads out automatically between the support and the motion element as a result of capillary forces. Precise and simple filling of the space between support and motion element is thus ensured. If the through hole is arranged as funnel-shaped, filling is simplified still further.

A further development of the motion element according to the invention comprises a protective coating on the motion device or the entire motion element to avoid direct contact with the motion device and the liquid to be treated. In biological applications a biocompatible coating, e.g. quartz, is advantageous here. In one embodiment with a surface acoustic wave generating device, the protective coating must be sufficiently thin so that the surface acoustic waves are not impeded by it and the momentum can be transferred to the liquid.

The motion element is advantageously arranged as transparent so that the spreading of the liquid can be observed. Optical investigations of the liquid or the reaction products of the liquid in contact with the motion element can also be carried out effectively through a transparent motion element. The motion element preferably consists of plastic, e.g. polycarbonate, polymethyl methacrylate (PMMA) or polyethylene terephthalate (PET). Plastic is cheap and easy to process. It can be manufactured simply, e.g. using an injection moulding method or using a milling plotter.

The motion device can be fixedly connected to the active principal surface of the motion element, e.g., as described above by adhesion. A detachable connection, e.g., a clamping connection, offers the simple possibility of being able to change defective motion devices more easily according to the requirement profile.

In another embodiment of the motion element according to the invention, a plurality of motion devices, are provided on the active principal surface of the plate in a regular arrangement in template form. The grid size of this template advantageously corresponds to the grid size of a conventional microtitre plate. Such an embodiment can be advantageously used to thoroughly mix simultaneously liquid samples in the recesses of a conventional microtitre plate. For this purpose the motion element of this embodiment according to the invention with the motion devices is placed on the microtitre plate and the motion devices are controlled to produce motion in the liquid. In an embodiment in which the motion devices comprise interdigital transducers, these are excited, for example, using an alternating voltage at the resonance frequency of the respective interdigital transducer.

This embodiment can thus be used to set in motion or agitate parallel individual quantities of liquid on a microtitre plate to homogenise or accelerate reactions of the quantities of liquid in the individual receptacles of the microtitre plate.

Independent protection is claimed for a motion device for producing motion in liquids which can preferably be used with the motion element according to the invention. Such a motion device according to the invention comprises a piezoelectric substrate or a substrate with a piezoelectric coating. Furthermore, the motion device according to the invention comprises at least one surface acoustic wave generating device on one of its surfaces. The surface acoustic wave generating device preferably comprises an interdigital transducer which, if necessary, is covered with a protective coating as has already been described above.

A preferred embodiment of the motion device comprises a plurality of surface acoustic wave generating devices arranged laterally offset to one another, preferably a plurality of interdigital transducers having different resonance frequency. Such an embodiment offers the advantages already described above with reference to the corresponding embodiment of the motion element according to the invention.

The motion device according to the invention can also be used independently of the motion element according to the invention, e.g., in a microfluidic system consisting of microchannels in order to move, drive or thoroughly mix liquids moving therein. The motion device according to the invention can in this case be arranged, for example, parallel, perpendicular or obliquely to a direction of motion of the liquid in the microfluidic system and both on the walls, the upper termination and at the bottom of the microfluidic system. The motion device can be arranged as an integral component of the microfluidic system, i.e., fixedly connected thereto and installed.

In another application of the motion device according to the invention this is not an integral component of a microfluidic system but is arranged loose. Such a loose motion device according to the invention can be used individually at various locations e.g. of a microfluidic system, a microanalysis or microreaction system. At the desired time the motion device can be brought in contact with the liquid in the system at the desired location, e.g. by immersing. Controlling the motion device according to the invention using a high-frequency signal generates a surface acoustic wave which is transferred to the liquid and thus results in thorough mixing, agitation or motion of the liquid in the sense described. The high-frequency signal can be coupled in in a wireless fashion or via contact leads which can also serve to retain the loose motion device. Such a loose motion device can be constructed, for example, in the form of a mixer stick. In this case, the motion device according to the invention is affixed to a support which, for example, can be immersed in the liquid inside a microfluidic system. The support can, for example, be a suitably dimensioned needle whose movement can be robot-controlled.

In a method according to the invention for producing motion in small quantities of liquid, a small quantity of liquid is brought in contact with a surface on which it is brought into interaction with at least one surface acoustic wave. The interaction with the surface acoustic wave produces effective motion, thorough mixing or distribution of the liquid as a result of the momentum transfer of the surface acoustic wave to the liquid or the constituents contained therein.

The method according to the invention can, for example, be implemented using a motion element according to the invention with motion devices located thereon or thereat. Equally the method according to the invention can be implemented using a motion device according to the invention which, for example, is fixedly installed in a microfluidic system or arranged loosely in order to be dipped in a liquid or brought in contact with said liquid which is located in a microfluidic system.

An advantageous embodiment of the method provides that the quantity of liquid interacts at different times with surface waves at different locations. Such an advantageous method can be achieved, for example, using a motion device having a plurality of surface acoustic wave generating devices laterally offset to one another. Controlling the individual surface acoustic wave generating devices according to a pre-determined program produces a time-varying flow pattern with which, for example, the formation of a stable flow can be prevented.

A cartridge according to the invention for receiving a motion element according to the invention has a receiving space for a support on which a liquid can be deposited. The cartridge according to the invention furthermore has a second receiving space in which the motion element according to the invention can be accommodated and specifically such that the motion device of the motion element according to the invention can come in contact with a liquid located on the support in the first receiving space. Furthermore, the cartridge according to the invention has devices for implementing the electrical contacting of the motion device on the motion element according to the invention. A support on which a liquid is located or on which a liquid is deposited is inserted in such a cartridge. A motion element according to the invention is inserted in the second receiving space. Depending on the embodiment, it is possible to separate the support and the motion element from one another by suitably dimensioned spacers. However, the cartridge can also have suitable devices which maintain a desired spacing. An electrical supply which activates the motion devices is applied to the at least one motion device of the motion element according to the invention via the electrical contacts. The motion devices set the liquid in motion and thus make it possible to achieve effective distribution or thorough mixing. The cartridge makes it possible to achieve simple and safe handling.

The devices for electrical contacting can be metal connections which are arranged in the cartridge such that a motion device on a motion element according to the invention which is inserted in the second receiving space of the cartridge, comes in contact with these metal connections. In such an embodiment the metal connections are arranged such that they are contactable from outside the cartridge to apply an electrical supply. In a particularly simple embodiment the devices for electrical contacting consist of through openings for external electrical connections. With a motion element inserted in the cartridge its motion devices can thus be brought into communication with metal contacts from outside in order to ensure an electrical supply to the motion devices.

A particular further development of the cartridge according to the invention has a cover with the aid of which the receiving spaces can be closed to produce an enclosed space and/or to fix the motion element in the cartridge. In addition, defined experimental conditions are produced by closure with a cover. In addition, a reservoir can be provided, for example, in which liquid is located during operation in order to maintain a constant air humidity in the spaced enclosed by the cover.

Especially advantageously a spring element is provided which can fix the motion element if necessary via spacers against the support with the liquid. A simple arrangement comprises a spring plate in the cover of the cartridge which presses the motion element towards the support on closing the cover. Special fixing with screws, for example, is not necessary.

Naturally a cartridge can also comprise a plurality of receiving possibilities for support, liquids and motion elements which, for example, are closed with a cover.

In the intermediate space between the support and the motion element, the liquid can spread out as a result of capillary action, for example, without air bubbles forming. Effective distribution/thorough mixing is then implemented or assisted using the motion element.

A heating device, e.g. a resistance heater, can be provided in the cartridge which can be used during the distribution or thorough mixing of the liquid to heat said liquid in order to promote a reaction, for example.

A particular embodiment of a cartridge with heating device comprises a heating plate which transfers heat applied externally to the cartridge to the support or liquid located thereon. Such a heating plate is preferably made of good heat-conducting metal.

In order to determine the temperature in the receiving spaces or the temperature of the inserted quantity of liquid, a thermometer element can be provided in the cartridge.

In a different embodiment the motion element can be fixed in or on the cover of the cartridge so that on closing the cover of the cartridge, it comes in contact with one or a plurality of small quantities of liquid on the support in the first receiving space in order to set this in motion.

A cartridge according to the invention can be dimensioned to receive a conventional microlitre plate so that a plurality of quantities of liquid can be moved in parallel in the individual receptacles of the microtitre plate.

A reaction device according to the invention is used to receive a cartridge according to the invention. Furthermore, contact elements are provided which are arranged such that they can come in electrical contact with a motion element according to the invention located in a cartridge which is accommodated in the cartridge receiving space. The reaction device according to the invention furthermore has an alternating voltage generating device to generate an alternating voltage which can be applied via the contact elements to such a motion element.

The cartridge receiving space need not necessarily comprise a recess to accommodate the cartridge but can also be formed by suitable fixing means, e.g., clamping devices.

Should a cartridge having through holes for contacting a motion element be used, the contact elements of the reaction device are corresponding electrical connecting pins which grip through these through holes when the cartridge is accommodated in order to bring the motion element in electrical contact with the motion device. The alternating voltage generating device is used to produce an alternating voltage which, for example, with a motion device having an interdigital transducer to produce surface acoustic waves, makes available the corresponding alternating voltage used to produce the surface acoustic waves.

In order to fix the cartridge in the cartridge receiving space, in one advantageous embodiment suitable closures or clamping devices are provided.

Input means can be provided which are used to select the corresponding parameters. In order to control the individual components of the reaction device, there is advantageously provided a microprocessor which, if necessary, is connected to the input device, the display means, the alternating voltage generating device. Finally a reaction device according to the invention can have an interface for external readout or control, e.g., using a computer. When using a motion element with a motion device having a plurality of surface acoustic wave generating devices, e.g., interdigital transducers, the running of a pre-determined program can also be controlled via such an interface or using an integrated microprocessor, whereby the individual interdigital transducers are controlled in a stipulated time sequence in order to impose a characteristic non-stationary flow pattern on a quantity of liquid which prevents laminar or stable flow. If necessary, a thermometer can also be read out and/or a heating device can be controlled using the microprocessor or via the interface so that temperature control can be achieved.

One embodiment of the reaction device according to the invention comprises display means on which the set parameters can be displayed.

Naturally, a reaction device according to the invention can also comprise a plurality of receiving spaces for a plurality of cartridges which can be addressed by a control unit if necessary.

A heating device, e.g. a resistance heater, can be provided in the cartridge receiving space, which, via an inserted cartridge, can heat a liquid contained therein in order to support a reaction. This heating can naturally also be controlled by a control device which may be present. Such a heating device advantageously interacts with a heating plate which is provided in a particular embodiment of the cartridge. If a cartridge according to the invention is used which has its own heating, e.g., resistance heating, connections are provided in the reaction device according to the invention which can provide an electrical supply to the cartridge heating when the cartridge is inserted.

As a result of simple handling and control, a reaction device according to the invention makes it possible to achieve a reaction such as is advantageous, for example, for series investigations of different reagents. Safe and simple handling speeds up the corresponding processes.

Using the apparatus according to the invention, it is possible, for example, to study or identify macromolecules in liquids. For this purpose, a support is used on which spots with macromolecules in a known arrangement have already been applied or are applied using a pipetting robot, dispenser or spotter. Such a support is inserted in the first receiving space of a cartridge according to the invention. If necessary, spacers are then placed on the support. A motion element according to the invention is deposited in the second receiving space of the cartridge according to the invention such that the motion device, that is the interdigital transducer, for example, points in the direction of the support. A liquid is inserted between the support and the motion element. The cartridge is closed and inserted in the reaction device according to the invention. The motion device is now activated by controlling the reaction device according to the invention, e.g. a suitable alternating voltage is applied to an interdigital transducer. In one embodiment with a plurality of surface acoustic wave generating devices on a motion device, these are controlled according to a pre-determined program to produce a non-stationary flow pattern in the liquid. The liquid in which the macromolecules to be studied are located is effectively and rapidly distributed by the motion brought about by the motion device. The macromolecules located in the liquid and the macromolecules located on the support undergo a hybridisation reaction if necessary. The support can then be studied to determine at which sites which macromolecules have formed a bond with the macromolecules in the liquid. In this way the property and type of the individual macromolecules can be determined. Such a method is suitable for use, for example, in DNA screening.

Naturally however, other reactions and processes can also be studied. For example, a tissue section can be inserted between the support and motion element. Its interaction with a liquid distributed using the motion element according to the invention can then be studied.

Special embodiments of the devices according to the invention are explained in detail below with reference to the appended drawings. The figures are of a schematic nature and are not necessarily true to scale. In the figures:

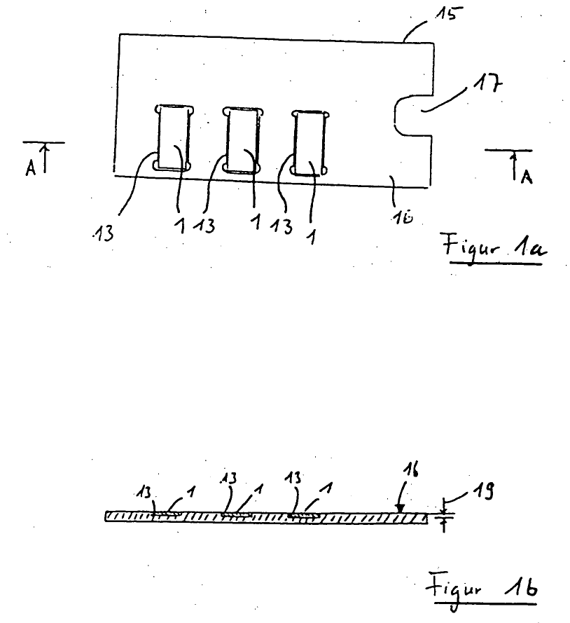

FIG. 1a is a plan view of an embodiment of a motion element according to the invention,

FIG. 1b is a schematic sectional view along the plane A-A in FIG. 1a,

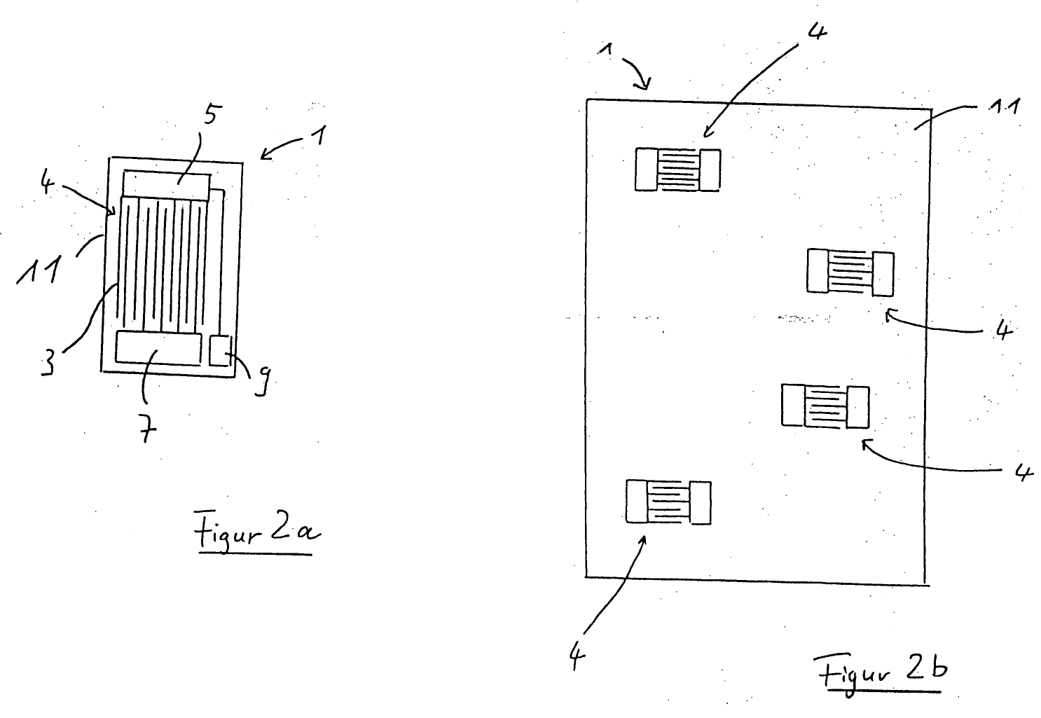

FIG. 2a is a schematic plan view of an embodiment of a motion device according to the invention,

FIG. 2b is a schematic plan view of another embodiment of a motion device according to the invention,

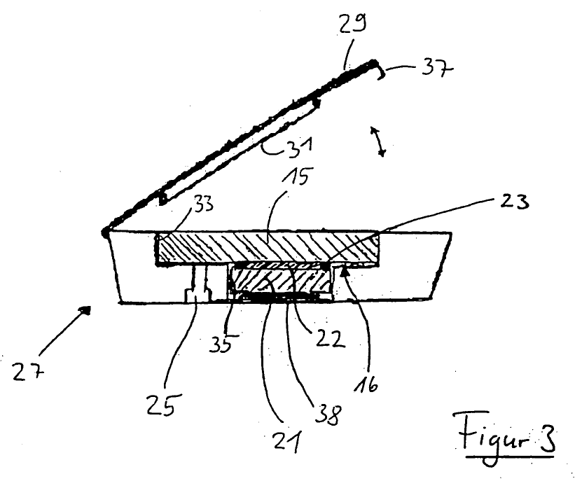

FIG. 3 is a sectional side view of an embodiment of a cartridge according to the invention,

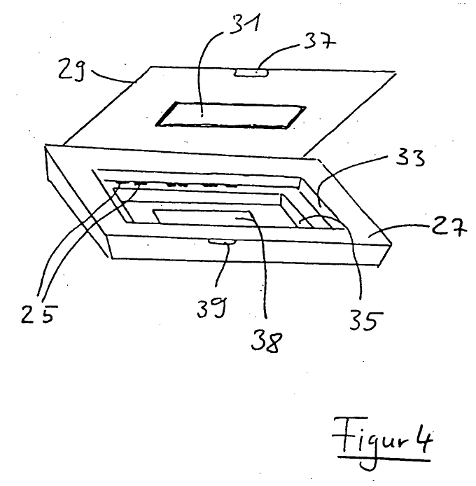

FIG. 4 is a perspective view of a cartridge according to the invention,

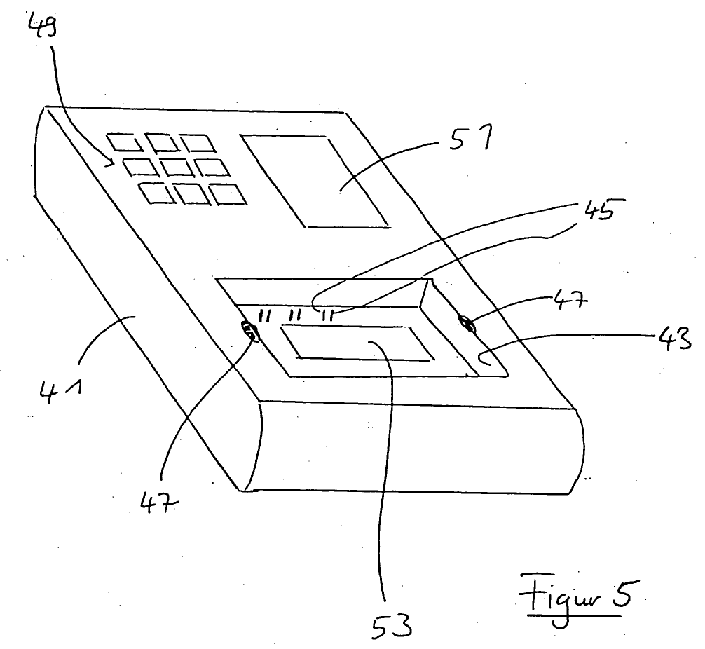

FIG. 5 is a perspective view of a reaction device according to the invention,

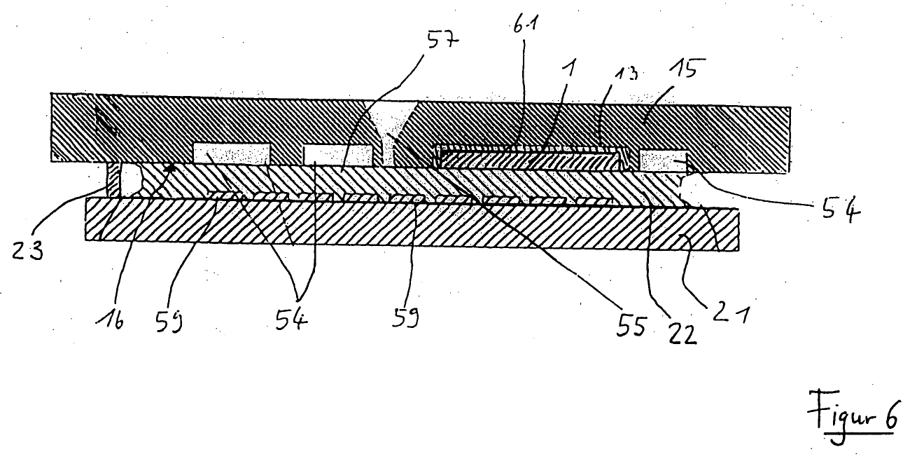

FIG. 6 is a partial sectional view of a motion element according to the invention during use,

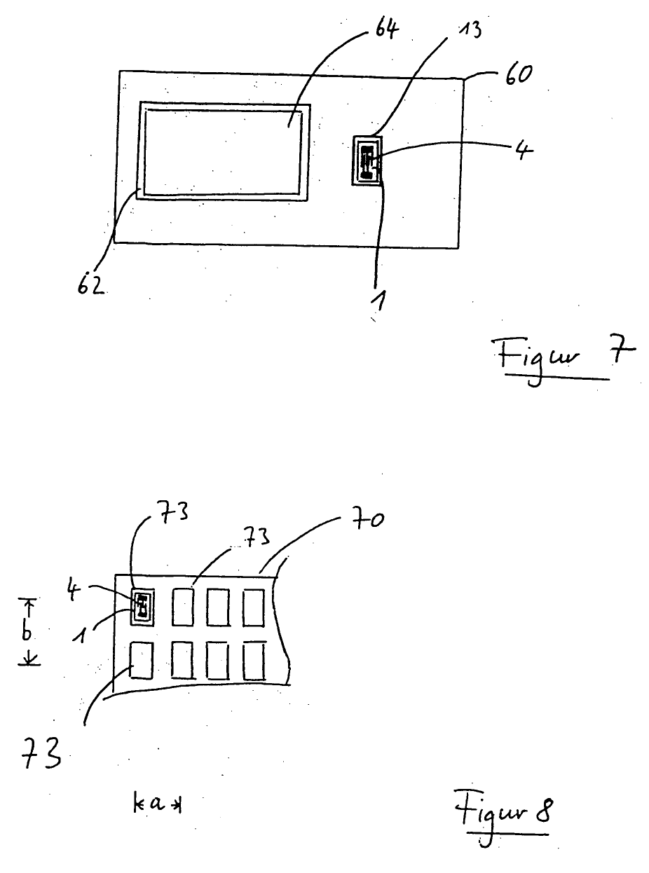

FIG. 7 is a plan view of another embodiment of a motion element according to the invention,

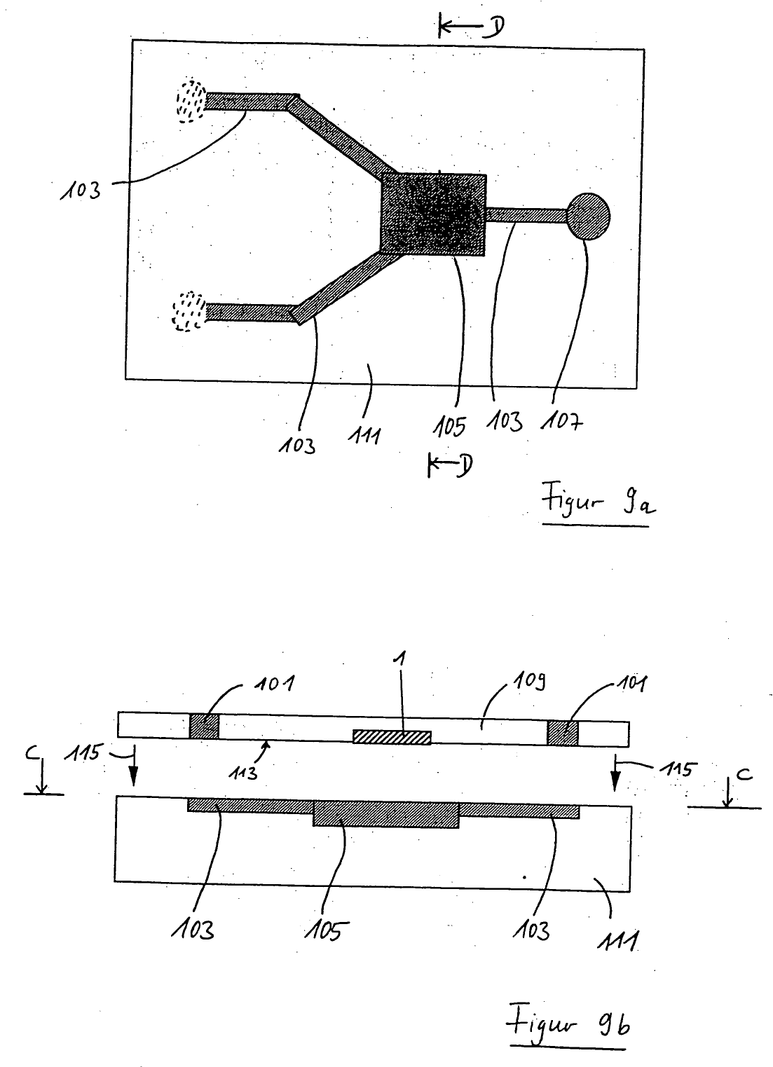

FIG. 8 is a partial plan view of another embodiment of a motion element according to the invention,

FIG. 9 is a microfluidic system for use with a motion element according to the invention, and

FIG. 9b is partial sectional side view to illustrate the use of a motion element according to the invention with a microfluidic system.

FIG. 1a shows a motion element according to the invention with the active surface viewed from above. This comprises a plastic card 15 having dimensions approximately corresponding to a conventional slide. The card is rectangular, for example, 25 mm×75 mm. The card 15 comprises receptacles 13 for motion devices 1 which are explained in detail with reference to FIGS. 2a and 2b and are not shown in detail in FIG. 1a. On one side of the card 15 a recess 17 is provided which is used for easier removal from a receiving space 33 in a cartridge 27, as described further below.

FIG. 1b shows a sectional side view approximately in the position A-A in FIG. 1a. The active principal surface of the card 15 shown in FIG. 1a is denoted by 16. The receptacles 13 for the motion devices 1 are recesses of height 19 which is selected such that the motion devices 1 terminate approximately in the plane of the principal surface 16.

FIG. 2a shows an embodiment of a motion device 1 according to the invention which comprises a chip 11, for example, made of piezoelectric lithium niobate or quartz.

The dimensions of the receptacles 13 in the motion element 15 are adapted to the dimensions of the motion devices 1 to be accommodated and can be, for example, 8×16 mm with a height of 0.5 mm. The dimensions of the chip 11 are such that it can be accommodated in a receptacle 13.

Located on one surface of the chip 11 in the embodiment shown is an interdigital transducer 4 having the simplest design as is known from surface wave filter technology. Other designs comprise, for example, non-parallel or non-equidistant finger-like electrode according to the requirement. The interdigital transducer 4 comprises electrodes 5 and 7 with intermeshing finger-like extensions 3. The diagram is merely schematic. The actual design comprises, for example, a much larger number of finger-like electrodes. In the embodiment shown the electrode 5 is connected to a connecting electrode 9 for easier contacting. Applying an electric alternating field having a magnitude of a few tens to a few hundred MHz generates a surface acoustic wave in-the surface of the piezoelectric crystal 11 if the resonance condition is approximately satisfied that the frequency of the alternating voltage corresponds to the quotient of the surface acoustic velocity and the finger spacing. The direction of propagation of the surface acoustic wave is perpendicular to the electrode fingers 3. Various interdigital transducer geometries can be used, as are known from surface wave filter technology.

The chip 11 of the motion device 1 is inserted in the card 15 in the receptacles 13, e.g. clamped in so that the interdigital transducer 4 lies approximately in the plane 16. The contacts 7 and 9 are thus accessible from outside.

FIG. 2b shows another embodiment of a motion device 1 according to the invention. A plurality of interdigital transducers 4 with different resonance frequencies are provided. For this purpose the individual interdigital transducers have different finger spacings or different geometries which however are not taken into account in the merely schematic FIG. 2b. The interdigital transducers 4 are connected in parallel with each other and connected to two connecting electrodes in a fashion not shown here for the sake of clarity.

In another embodiment not shown here the motion elements 1 are contacted laterally or from below with the electrode configuration of the interdigital transducers being suitably arranged. In such an embodiment the card 15 comprises electrical leads which are guided either onto the side or onto the surface of the card 15 located opposite the principal surface 16 and can be contacted from there. Alternatively, the interdigital transducers can be wirelessly controlled by emitting an electrical alternating field. For this purpose the electrodes 5 and 7 are connected in a suitable fashion to receiving devices (antennae) which can also be arranged on the chip.

FIG. 3 shows a cross-section through a cartridge 27 according to the invention. The cartridge 27 comprises a plastic casing with a first receiving space 35. This receiving space is used to accommodate a support 21 e.g., a slide. The dimensions of the receiving space 35 are matched to those of the support structures used. The receiving space 35 opens out into a wider receiving space 33 whose dimensions are sufficient to accommodate a motion element 15. The receiving space 33 is connected to the back of the cartridge by a through hole 25. The cartridge 27 has a cover 29 hinged in the fashion shown with a spring plate 31. FIG. 3 shows the cartridge 27 with inserted support, inserted motion element 15 and opened cover. The support 21 lies in the receiving space 35. Located on the support either in one piece or as separate elements are a plurality of spacers 23 on which the plastic card 15 rests. Said card has its principal active surface 16 in the direction of the support 21. Closing the hinged cover 29 brings the spring plate 31 in communication with the plastic card 15 so that this is pressed against the spacer 23 or the support 21. The through holes 25 are arranged such that an inserted motion element 15 with the electrodes 7 and 9 of the respective motion devices 1 comes to lie above the through holes 25 which are provided in a suitable number.

38 denotes a metal heating plate which is let into the bottom of the cartridge 27. Said plate is used to transfer heat applied externally at the bottom of the cartridge to the support or the liquid on the support. Not shown is a resistance thermometer which is arranged in the cartridge 27 to determine the temperature.

22 denotes the intermediate space between the inserted support 21 and the inserted motion element 15. The liquid to be moved is located in the gap 22 during operation.

Unlike the embodiment shown in FIG. 3, the motion element 15 can be fixed to the cover 29 and only come into the position shown in FIG. 3 by closing the cover.

FIG. 4 again shows a perspective view of the cartridge 27 wherein the closure clamping elements 37 and 39 used to close the cover are also shown. Typical dimensions for a cartridge are a height of 1.5 cm and lateral dimensions of, for example, 14 cm×6.5 cm. In this size a cartridge is easy to handle.

FIG. 5 shows a reaction device according to the invention. The reaction device has a cartridge receiving space 43 whose dimensions are arranged such that it can accommodate or retain a cartridge 27. Fixing elements 47, e.g., spring clips, are used for this purpose. A heating element 53, e.g. a resistance heater, is located inside the cartridge receiving space 43. When the cartridge 27 is inserted in the cartridge receiving space 43, the resistance element 53 comes in contact with the heating plate 38 of the cartridge 27 and can thus effectively transfer heat generated at the resistance element 53 to the support 21 or the liquid located thereon.

45 denotes spring pin contacts which engage in the through holes 25 when the cartridge 27 is inserted. The reaction device also has a keypad 49 by which means parameters can be entered to control the reaction device. Adjacent thereto a display device 51 can be seen which is used, for example, to display the selected parameters. The reaction device comprises a casing 41 in which is located a non-visible alternating voltage generating device suitable for generating an alternating voltage at a frequency of a few tens to a few hundred MHz. This alternating voltage generating device supplies the spring pin contacts 45 with the corresponding voltage which supplies the interdigital transducer 4 via the electrodes 7 and 9 when the cartridge 27 is inserted with the motion element 15 located therein. Furthermore, a corresponding microprocessor control is provided in the casing 41 which takes over control of the resistance element 53, the spring pin contacts 45, the display 51 and the input keypad 49.

FIG. 6 shows a schematic partial view of the element inserted in a cartridge 27, not shown here, during operation. An embodiment is shown in which macromolecules in a known arrangement of spots 59 are located on a support 21. Resting on the support 21 are spacers 23 which in turn support the motion element 15. An embodiment is shown with a funnel-shaped through hole 55 and blind holes 54 whose lateral dimensions are greater than the spacing between the support 21 and motion element 15 which is maintained by the spacer 23. Located in the gap 22 between the motion element 15 and the support 21 during operation is a liquid 57 which, for example, can contain other macromolecules whose hybridisation with the macromolecules bound in the spots 59 is to be studied. Also shown is the motion device 1 which is glued in the receptacle 13 using the adhesive 61 which ends flush with the motion device 1 and the motion element 15. The adhesion is accomplished in a simple fashion using a capillary adhesion method. The motion device 1 is inserted in the receptacle 13. A liquid adhesive is inserted in the gap between the motion device 1 and the receptacle 13 which spreads uniformly in the gap as a result of the capillary action and ensures a flush termination with the surfaces.

The components of the system according to the invention can be used as follows. A use is again described in which the hybridisation of macromolecules is to be investigated.

A support 21 with a known arrangement of spots 59 of macromolecules is inserted in the cartridge 27. Spacers 23 are placed on the support 21. A motion element 15 is inserted in the receiving spaces 33 of the cartridge 27 with the active surface 16 in the direction of the support 21 and specifically such that the electrodes 7, 9 of the motion devices 1 come to lie above the through holes 25. Liquid containing second macromolecules is inserted through the through hole 55 into the gap between the motion element 15 and the support 21. As a result of the capillary action the liquid in the gap 22 moves outwards and covers the spots 59 of macromolecules. Air located in the gap is pressed outwards so that no air bubbles can form If no through hole 55 is present, the liquid is first deposited on the support 21 before the motion element 15 is inserted.

The cartridge 27 is closed by closing the cover 29 so that the spring plate 31 presses the motion element 15 towards the support 21. The cover is closed with the closure elements 37 and 39.

The closed cartridge 27 is inserted in the cartridge receiving space 43 of the reaction device in FIG. 5. Naturally, the cartridge can also be already located in the reaction device if the individual components are inserted in the cartridge 27.

During insertion of the cartridge 27 in the reaction device the spring pin contacts 45 pass through the through holes 25 and come in contact with the electrodes 7 and 9 of the individual interdigital transducers 4 of the motion devices 1. The cartridge is held with the fixings 47 in the casing 41 of the reaction vessel.

By means of a suitable input via the keypad 49 an alternating voltage is applied to the spring pin contacts 45 from the alternating voltage device of the reaction device, which voltage is applied via the electrodes 7 and 9 to the interdigital transducers 4 of the individual motion devices 1 and generates a surface acoustic wave in the surface of the chip 11. This transfers its momentum to the liquid 57.

In the liquid motion is excited by the surface acoustic wave which ensures an optimum distribution of the liquid over the spots 59. Furthermore, the surface acoustic wave provides effective thorough mixing of the liquid. The macromolecules in the liquid can hybridise with the macromolecules in the spots 49. If necessary, the heating plate 38 of the cartridge 27 is heated using the resistance heating 53 of the reaction device, which in turn heats the support 21 and the liquid located therein in order to support the reaction. After the typical hybridisation time, which is substantially shortened compared with normal diffusion-operated systems, the support 21 can be removed and studied to determine at which of the spots 59 hybridisation has taken place. In this way information can be obtained on the type of individual macromolecules. Thus, for example, DNA screening can also be effectively carried out.

In one embodiment using a motion device 1 as shown in FIG. 2b the various interdigital transducers 4 are controlled according to a pre-determined time program so that at different times a surface acoustic wave interacts with the liquid at different locations. In this way a non-stationary flow pattern is produced which supports distribution and/or thorough mixing.

FIG. 7 shows another embodiment of a motion element 60 according to the invention. The motion element 60 is card-shaped and rectangular having dimensions of, for example, 35 mm×85 mm. A receiving recess 62 is provided in the motion element 60, whose dimensions are designed to receive a conventional slide. 64 denotes an inserted slide whose surface lies in one plane with the surface of the motion element 60. A microarray of macromolecules, for example, can be located in the slide 64.

A motion device 1 according to the invention is arranged in another recess 13.

Such a motion element 60 can be used a follows. A slide 64 with a microarray with macromolecules in a known arrangement is inserted in the receiving recess 62. A liquid containing other macromolecules is deposited on the card-shaped motion element 60. The liquid is in contact with both the motion device 1 and the slide 64. Applying an electric alternating field to the interdigital transducer 4 of the motion device 1 generates surface acoustic waves which transfer their momentum to the liquid or the constituents contained therein. The motion of the liquid continues through the entire quantity of liquid and produces a characteristic flow pattern also in the area of the liquid above the slide 64. Optimum thorough mixing and distribution is achieved here, which promotes hybridisation of the macromolecules in the liquid with the macromolecules on the slide 64.

Such a motion element 60 according to the invention can also be used in a cartridge 27 according to the invention if the liquid to be studied is deposited on the support 21 and the motion element 60 is inserted in the receiving space 33 with the active surface in the direction of the support 21.

The use of the devices according to the invention and the system according to the invention is naturally not limited to the study of macromolecules. The system is suitable for reactions in which the effective distribution and thorough mixing of a liquid is required.

FIG. 8 shows a section of a motion element according to the invention 70 for use with a conventional micro-titre plate. A plurality of receptacles 73 are provided in which individual motion devices 1, e.g., piezoelectric substrates with interdigital transducers 4 are provided. The spacing of the individual motion devices 1 corresponds to the typical grid size of a conventionally available microtitre plate. Quantities of liquid which are incorporated in the liquid receptacles of a microtitre plate can easily be agitated or mixed in parallel using this embodiment 70 according to the invention. For this purpose the motion element 70 according to the invention with the motion devices 1 is placed on the microtitre plate with the quantities of liquid contained therein. By applying suitable alternating voltages to the motion devices 1, the interdigital transducers 4 of the motion device 1 can be excited to produce surface acoustic waves which are transferred to the quantities of liquid in the individual liquid receptacles of a microtitre plate.

FIG. 9b shows another embodiment of a motion element according to the invention in a schematic partial side sectional view. A motion device 1, e.g. a chip with a surface wave generating device is located in a card-shaped member 109. Not shown are the electrical connections to control the motion device 1 which, however, are similar to the contacting possibilities described with reference to the above embodiments. Passages 101 are located in the card-shaped member 109.

The motion element according to the invention can be used together with a conventional microfluidic system shown as 111 in FIG. 9b. FIG. 9a shows a plan view of a surface of the microfluidic system in the viewing direction of the arrow C, as indicated in FIG. 9b. 103 denotes microfluidic channels as can conventionally be formed, for example, by etching. 105 is a recess in which a liquid to be mixed or agitated can remain. 107 denotes an opening through which the liquid can flow away again. This opening can be provided, for example, in the microfluidic system 11 or in the card-shaped member 109. In FIG. 9a dashed lines indicate those locations which come in contact with the opening 101 when the card-shaped member 109 is applied to the microfluidic system 111 in the direction of the arrow 115.

The arrows D in FIG. 9a show the viewing direction of FIG. 9b. In FIG. 9b the channels 103 and the openings 101 are additionally indicated although these do not lie in the viewing plane D-D.

Such an embodiment can be used as follows. The motion element according to the invention is deposited on a microfluidic system in the direction of the arrows 115. Liquid is incorporated into the microfluidic system through the openings 101. Said liquid flows along the channels 103 in the direction of the recess 105. The motion device 1, e.g., an interdigital transducer as described with reference to the above embodiments is electrically excited and results in thorough mixing or agitation of the liquid in the recess 105. The liquid can then flow off through the drain 107. The process can take place continuously, for example, while the liquid moves along the channels 103.

The system and the individual components allow easy handling. During frequent usage it is advantageous that the individual components do not require great skill during handling. In particular, the simply constructed motion element makes it possible to achieve effective distribution and thorough mixing of liquids in a simple fashion.

1. A motion element for producing motion in small quantities of liquid comprising
a plate (15, 60, 70, 109) with two principal surfaces,
at least one motion device (1) arranged on an active first principal surface (16, 113) of the plate (15, 60, 70, 109), which is electrically controllable, to set a quantity of liquid (57) in motion, which is in contact with the active principal surface (16), and
electrical contact elements for the at least one motion device (1).

2. The motion element according to claim 1, wherein the at least one motion device (1) comprises at least one surface acoustic wave generating device (4).

3. The motion element according to claim 2, wherein the motion device (1) comprises a plurality of surface acoustic wave generating devices (4) arranged laterally offset to one another.

4. The motion element according to claim 2, wherein the at least one surface acoustic wave generating device (4) is arranged on a chip (11), preferably a solid chip made of crystalline material.

5. The motion element according to claim 4, wherein the at least one surface acoustic wave generating device comprises an interdigital transducer (4) and the chip (11) is piezoelectric or has a piezoelectric surface area.

6. The motion element according to claim 3, wherein the motion device (1) has a plurality of interdigital transducers (4) having different resonance frequency.

7. The motion element according to claim 2, wherein the at least one motion device (1) is accommodated in a recess (13, 73) of the active principal surface (16, 113) such that the surface acoustic wave generating device (4) and the active principal surface (16, 113) lie substantially in one plane.

8. The motion element according to claim 7 with a receiving recess (62) for a slide (64) having lateral dimensions which allow receipt of the slide (64) and a depth which approximately corresponds to the thickness of one slide.

9. The motion element according to claim 2 with preferably smooth-walled blind holes (54) in the active principal surface (16, 113).

10. The motion element according to claim 1, wherein the plate (15, 60, 70, 109) is card shaped.

11. The motion element according to claim 1, with at least one through hole (55, 101) which connects the active principal surface (16, 113) to the second principal surface and opens preferably in a funnel shape towards the second principal surface.

12. The motion element according to claim 1, with a preferably biocompatible protective coating at least on the motion device (1).

13. The motion element according to claim 1, wherein the plate (15, 60, 70) is at least partly transparent.

14. The motion element according to claim 1, wherein the plate (15, 60, 70) is made of plastic, preferably polycarbonate, polymethyl methacrylate (PMMA) or polyethylene terephthalate (PET).

15. The motion element according to claim 1, wherein at least one motion device (1) is detachably connected to the plate (15, 109).

16. The motion element according to claim 1, wherein the electrical contact elements comprise an antenna device through which an electrical control signal can be coupled wirelessly into the electrical contact elements.

17. The motion element according to claim 1 with a plurality of motion devices (1) on the active principal surface of the plate (70) in regular arrangement in template form with a grid size (a, b) which corresponds to the grid size of a microtitre plate.

18. A motion device for small quantities of liquid, comprising
a piezoelectric substrate (11) or a substrate with piezoelectric coating, and
at least one surface acoustic wave generating device (4) on one surface of the substrate (11).

19. The motion device according to claim 18 which comprises a plurality of surface acoustic wave generating devices (4) which are arranged laterally offset to one another.

20. The motion element according to claim 18, wherein the at least one surface acoustic wave generating device comprises at least one interdigital transducer.

21. The motion device according to claim 20 comprising a plurality of interdigital transducers (4) having different resonance frequency.

22. The motion element according to claim 18, with a preferably biocompatible protective coating protective coating on the at least one surface acoustic wave generating device (4).

23. A method for producing motion in small quantities of liquid (57) is brought in contact with a surface (16, 113) and is brought into interaction with at least one surface acoustic wave on the surface.

24. The method according to claim 23, wherein the small quantity of liquid is located in a microfluidic system.

25. The method according to claim 23, wherein the small quantity of liquid is located on a microtitre plate.

26. The method according to claim 23 wherein the small quantity of liquid interacts at different times with surface acoustic waves at different locations.

27. A method for producing motion in small quantities of liquid wherein a plurality of quantities of liquid are located on a microtitre plate having a grid size (a, b), are brought in contact with the active principal surface of a motion element according to claim 17 and are set in motion with the aid of the motion devices (1) of the motion element.

28. A cartridge to receive a motion element (15, 60, 70, 109) according to claim 1, comprising
a first receiving space (35) for a support (21, 111) for at least one small quantity of liquid (57),
a second receiving space (33) to receive the motion element (15, 60, 70, 109) which is in communication with the first receiving space (35) such that a small quantity of liquid (57) located on a support (21, 111) in the first receiving space (35) can interact with a motion element (15, 60, 70, 109) accommodated in the second receiving space (33) and
devices (25) for executing the electrical contacting of the motion device (1) or motion devices arranged on the motion element (15, 60, 70, 109).

29. The cartridge according to claim 28, wherein the devices for electrical contacting comprise through openings (25) for electrical connections (45).

30. The cartridge according to claim 28 with a cover (29) for closing the receiving spaces (33, 35).

31. The cartridge according to claim 28 with a spring element (31) for fixing a motion element (15, 60, 70, 109) accommodated in the second receiving space (33) with respect to a support (21, 111) accommodated in the first receiving space (35).

32. The cartridge according to claim 28 with a heating element (38) preferably at the bottom of the cartridge for heating a quantity of liquid on a support (21, 111) inserted in the cartridge (27).

33. The cartridge according to claim 32, wherein the heating element is a resistance heater.

34. The cartridge according to claim 32, wherein the heating element comprises a preferably metal heating plate (38) for transferring externally applied heat to a support (21, 111) inserted in the cartridge.

35. The cartridge according to claim 28 with a thermometer element to determine the temperature of a small quantity of liquid (57) on a support (21, 111) inserted in the cartridge (27).

36. A reaction device for studying and/or reacting small quantities of liquid, comprising
a cartridge receiver (43) to accommodate a cartridge according to claim 28,
contact elements (45) which are arranged such that they can come in electrical contact with a motion element (15, 60 70, 109) in a cartridge (27) accommodated in the cartridge receiving space (43), and
an alternating voltage generating device to produce an alternating voltage which can be applied via the contact elements (45) to a motion element (15, 60, 70, 109) which is accommodated in a cartridge (27) located in the cartridge receiving space (43).

37. The reaction device according to claim 32 with a heating element (53) in the cartridge receiving space (43), preferably a resistance heating element.

38. A system for producing motion in a liquid comprising a motion element (15) according to claim 1.
